(19) United States
(12) Patent Application Publication
(10) Pub. No.: US 2010/0066612 A1
(43) Pub. Date: Mar. 18, 2010

(54) Wideband antenna

(75) Inventor: Lung-Sheng Tai, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION. CO., LTD.

(21) Appl. No.: 12/586,149

(22) Filed: Sep. 16, 2009

(30) Foreign Application Priority Data
Sep. 16, 2008 (TW) 97216670

(51) Int. Cl. H01Q 1/36; H01Q 1/48

(52) U.S. Cl. 343/700 MS; 343/846

(57) ABSTRACT

A wideband antenna includes a grounding element, a connecting element, a radiating element electrically connected to the connecting element, and a feeding line. The connecting element includes a first side arm extending from the grounding element and a second side arm having at least one bending portion. The second side arm includes at least one segment located on a plane different from a plane the first side arm located, and has an edge parallel to the grounding element. The radiating element includes a first radiating portion and a second radiating portion. The feeding line includes an inner conductor connected to the first radiating portion and an outer conductor connected to the grounding element.

### BACKGROUND OF THE INVENTION

1. Field of the Invention

The present invention relates generally to a wideband antenna, specially, that the wideband antenna is used in an electric device.

2. Description of the Prior Art

A planar inverted-F antenna is always used inside an electric device. For the electric device trending to be small and thin, the antenna inside the electric device should have the feature of small volume. TW Patent No. TW 12040450, issued to Cheng on May 1, 2005, discloses a planar inverted-F antenna. Referencing to FIG. 1 of the patent, the antenna includes a grounding element, a radiating element apart from the grounding element, and a connecting element serving to connect a radiating element and a grounding element. The connecting element includes a plurality of segments. The radiating element includes a plurality of radiating arms. However, all the segments of the connecting element and the radiating arms of the radiating element are arranged on the same plane so as to the antenna is too high. TW Patent No. TW 562257, issued to Cheng on Nov. 11, 2003, discloses a planar inverted-F antenna. Referencing to FIG. 3A of this patent, the antenna includes a three-dimensional connecting element. However, the antenna is not a wideband antenna.

Hence, in this art, an improved antenna to overcome the above-mentioned disadvantages of the prior art should be provided.

### BRIEF SUMMARY OF THE INVENTION

A primary object, therefore, of the present invention is to provide a wideband antenna with a three-dimensional connecting element.

In order to implement the above object, the wideband antenna comprises a grounding element, a connecting element, a radiating element electrically connected to the connecting element, and a feeding line. The connecting element comprises a first side arm extending from the grounding element and a second side arm having at least one bending portion. The second side arm comprises at least one segment located on a plane different from a plane the first side arm located, and has an edge parallel to the grounding element. The radiating element comprises a first radiating portion and a second radiating portion. The feeding line comprises an inner conductor connected to the first radiating portion and an outer conductor connected to the grounding element.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view illustrating a wideband antenna according to a preferred embodiment of the present invention;

FIG. 2 is a perspective view similar to FIG. 1, but including a feeding line and viewed from an angle different;

FIG. 3 is a test chart recording for an antenna of the wideband antenna of FIG. 1, showing Voltage Standing Wave Ratio (VSWR) as a function of UWB frequency.

### DETAILED DESCRIPTION OF THE INVENTION

Reference will now be made in detail to a preferred embodiment of the present invention.

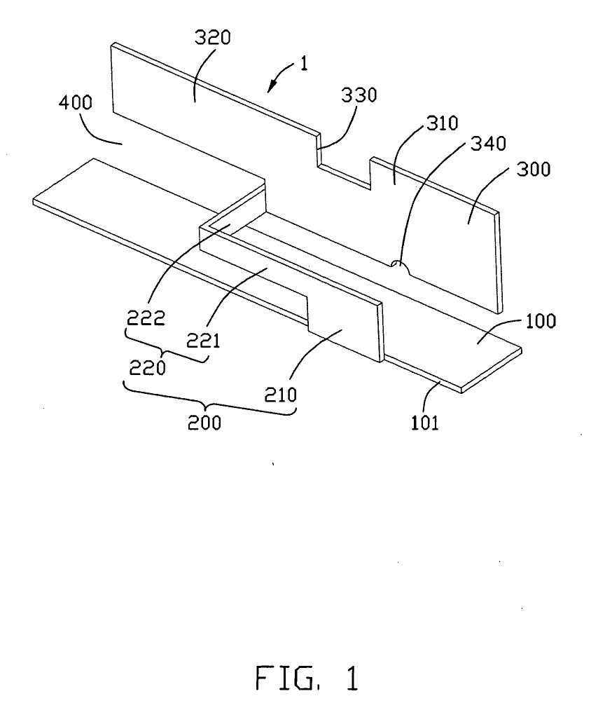

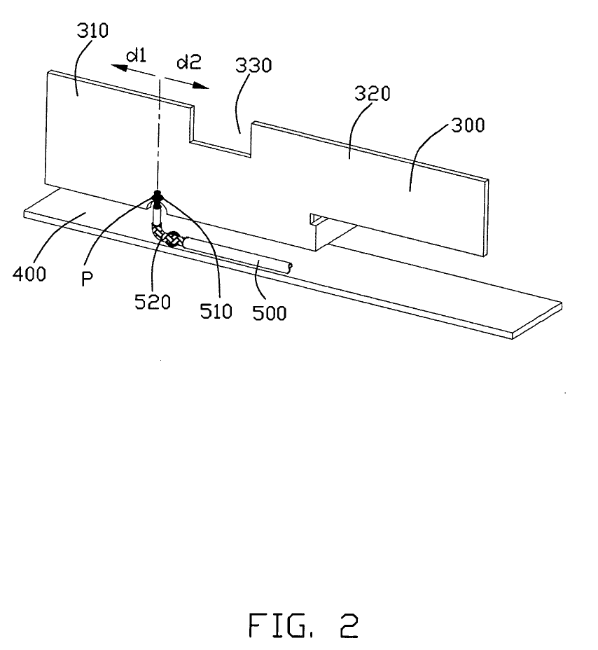

Reference to FIGS. 1 to 2, a wideband antenna 1 comprises a grounding element 100, a radiating element 300 apart from the grounding element 100, and a connecting element 200 connecting the grounding element 100 to the radiating element 300.

The grounding element 100 is of rectangular configuration and comprises a side edge 101. In this embodiment, the grounding element 100 extends along horizontal directions, and in other embodiments, the grounding element 100 could extend along vertical directions.

The connecting element 200 extends from one side of the grounding element 100 and comprises a first side arm 210 extending from the side edge of the grounding element 100, and a second side arm 220 extending from the first side arm 210 and connected to the radiating element 300. The first side arm 210 divides the side edge of the grounding element 100 to a shorter part and a longer part. The second side arm 220 is of L-shaped configuration, and comprises a first segment 221 located on the same plane with the first side arm 210 and a second segment 222 extending from the first segment 221 along a direction perpendicular to the first segment 221. The first side arm 210 and the second side arm 220 form a three-dimensional structure. An L-shaped slot 400 is formed between the connecting element 200 and the grounding element 100 to adjust the impedance of the wideband antenna 1. In this embodiment, the first side arm 210 is wider than the second side arm 220, and both the first side arm 210 and the second side arm 220 are perpendicular to the grounding element. In other embodiments, the first side arm 210 can be connected to the grounding element on another position, and the second side arm 220 can be designed as other shape only that the second side arm 220 must have at least one bending portion and have an edge parallel to the grounding element.

The radiating element 300 is connected to the second segment 222 of the connecting element 200. And the radiating element 300 is perpendicular to the second segment 222, parallel to the first segment 221 and the first side arm 210, and perpendicular to the grounding element 100. The radiating element 300 comprises a first radiating portion 310 extending from the connecting element 200 along a first direction and a second radiating portion 320 extending from the first radiating portion 310 along a second direction opposite to the first direction. The first radiating portion 310 is wider than the second radiating portion 320, so that the first radiating portion 310 and the second radiating portion 320 form an L-shaped configuration. The second radiating portion 320 is apart from the connecting element 200 and above the second segment 222 of the connecting element 200. Two tops of the first radiating portion 310 and the second radiating portion 320 are on the same level. The first radiating portion 310 has a cutout 330 on the top thereof and a gap 340 on the bottom thereof. Two side edges of the cut out 330 respectively extend along two vertical lines both different from vertical lines passing through the gap 340. A feeding point P is formed above the gap 340. In other embodiments, the positions of the cutout 330 and the gap 340 could be changed, further, the cutout 330 and the gap 340 could be deleted.

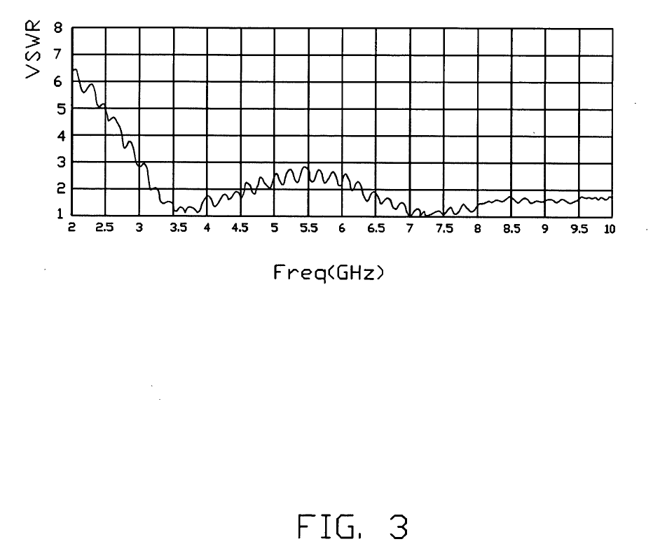

A feeding line 500 is connected to the feeding point P to provide current for the wideband antenna 1. The feeding line 500 comprises an inner conductor 510 and an outer conductor 520 connected to the grounding element 520. The current go from the feeding point P along the first direction d1 through a part of the first radiating portion 310 to operate a first higher frequency band, and go from the feeding point P along the second direction d2 through a part of the first radiating portion 310 and the second radiating portion 320 to operate a second lower frequency band. The radiating element 300 is divided to a higher-frequency-band radiating portion and a lower-frequency-band radiating portion by the feeding point P. Referencing to FIG. 3, it obviously that the wideband antenna 1 works on a higher frequency band on 6.3-10 GHz and a lower frequency band on 3.1-4.8 GHz.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wideband antenna, comprising:
a grounding element;
a connecting element, comprising a first side arm extending from the grounding element and a second side arm having at least one bending portion, said second side arm comprising at least one segment located on a plane different from a plane that the first side arm is located and having an edge parallel to the grounding element;
a radiating element electrically connected to the connecting element and comprising a first radiating portion and a second radiating portion; and
a feeding line, comprising an inner conductor connected to the first radiating portion and an outer conductor connected to the grounding element.

2. The wideband antenna as claimed in claim 1, wherein said first side arm of the connecting element is perpendicular to the grounding element.

3. The wideband antenna as claimed in claim 2, wherein said second side arm comprises a first segment extending from the first side arm along a direction perpendicular to the first side arm and a second segment extending from the first segment along a direction perpendicular to the first segment.

4. The wideband antenna as claimed in claim 3, wherein said wideband antenna further comprises an L-shaped slot between the second side arm of the connecting element and the grounding element.

5. The wideband antenna as claimed in claim 2, wherein said second side arm is perpendicular to the grounding element.

6. The wideband antenna as claimed in claim 1, wherein said radiating element comprises a first radiating portion extending from the connecting portion along a first direction and a second radiating portion extending from the first radiating portion along a second direction opposite to the first direction, said second radiating portion being apart form the connecting element.

7. The wideband antenna as claimed in claim 6, wherein the first radiating portion is wider than the second radiating portion and the two radiating portions are of substantially rectangular configuration.

8. The wideband antenna as claimed in claim 6, wherein said first radiating portion has a cutout on the top thereof.

9. The wideband antenna as claimed in claim 8, wherein said first radiating portion has a gap on the bottom thereof.

10. The wideband antenna as claimed in claim 9, wherein said cutout has two edges, and said two side edges of the cutout respectively extend along two vertical lines both different from vertical lines passing through the gap.

11. The wideband antenna as claimed in claim 9, wherein said wideband antenna further has a feeding point located above the gap, and the inner conductor of the feeding line is connected to the feeding point.

12. An antenna comprising:
a grounding element defining a plate with opposite first and second edges extending along a longitudinal direction;
a connecting element having a first part extending from the first edge in a first vertical plane extending along said longitudinal direction, and a second part extending from the first part toward the second edge in a second vertical plane extending in a transverse direction perpendicular to said longitudinal direction; and
a radiating element having a first segment extending from the second part in said longitudinal direction, and a second segment extending from the first segment in another longitudinal direction opposite to said longitudinal direction.

13. The antenna as claimed in claim 12, wherein said radiating element defines
a cutout in an upper edge closer to a boundary between the first segment and said second segment.

14. The antenna as claimed in claim 13, wherein said radiating element defines a notch in a lower edge opposite to a boundary between the connecting element and the grounding element in said transverse direction, and an inner conductor a feeder cable is solder around said gap while an outer conductor of said feeder cable is solder upon the grounding element.
